(19) United States
(12) Patent Application Publication
(10) Pub. No.: US 2008/0082845 A1
(43) Pub. Date: Apr. 3, 2008

(54) INFORMATION PROCESSING APPARATUS AND SYSTEM STATE CONTROL METHOD

(75) Inventor: Toshikazu Morisawa, Tokorozawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 11/864,510

(22) Filed: Sep. 28, 2007

(30) Foreign Application Priority Data
Sep. 29, 2006 (JP) 2006-268264

(51) Int. Cl. G06F 1/32

(52) U.S. Cl. 713/323

(57) ABSTRACT

According to one embodiment, an information processing apparatus includes a first state control unit which stores system information in a hard disk drive and then transitions a system state from a working state to a standby state, a restoration process unit which supplies power to a processor in a state in which the hard disk drive is kept in an inactive state, when a wakeup event has occurred, thereby restoring the system state to the working state, a determination unit which determines whether a factor of occurrence of the wakeup event is occurrence of an alarm signal for instructing transition to a hibernate state, and a second state control unit which stops power supply to the processor and a main memory if the factor of occurrence of the wakeup event is the occurrence of the alarm signal, thereby transitioning the system state to the hibernate state.

### CROSS-REFERENCE TO RELATED APPLICATIONS

This application is based upon and claims the benefit of priority from Japanese Patent Application No. 2006-268264, filed Sep. 29, 2006, the entire contents of which are incorporated herein by reference.

### BACKGROUND

1. Field

One embodiment of the invention relates to an information processing apparatus such as a personal computer, which can transition its system state, for example, between a working state, a standby state and a hibernate state.

2. Description of the Related Art

In general, in an information processing apparatus such as a personal computer, a hard disk drive is used as a storage device. The hard disk drive is a storage device in which data is stored in a disk storage medium which is called “hard disk”.

The power consumption of the hard disk drive, however, is relatively high. The reason is that the hard disk drive requires not only power for driving a controller within the hard disk drive but also power for rotating the disk storage medium.

Jpn. Pat. Appln. KOKAI Publication No. 6-309776 discloses a hard disk drive which is equipped with a power-saving function. This hard disk drive is provided with a nonvolatile memory for storing data which has been read out of the disk storage medium to a host computer. If data which is requested from the host computer is stored in the nonvolatile memory, the requested data is read out of the nonvolatile memory to the host computer. In this case, since the disk storage medium is not rotated, the power consumption of the hard disk drive can be reduced.

In the meantime, in usual cases, in the personal computer, a standby state and a hibernate state are supported as power-saving states.

The standby state (also referred to as “suspend state”) is a power-saving state in which almost all devices, excluding a main memory for storing system information, are powered off. The hibernate state is a power-saving state in which almost all devices, including the main memory, are powered off after the system information is stored in the hard disk drive.

The standby state is the power-saving state in which the personal computer can be restored to a working state more quicker than in the hibernate state. However, in the standby state, power is consumed for backup of the main memory. Consequently, if the standby state continues for a long time, much power would be consumed and the battery driving time in a portable computer would decrease.

It is thus necessary to realize a novel function for efficiently transitioning the system state from the standby state to the hibernate state. In this case, it is necessary to minimize the power which is consumed by the transition from the standby state to the hibernate state. The reason is that if relatively much power is consumed when the system state is transitioned from the standby state to the hibernate state, the advantageous effect of the transition from the standby state to the hibernate state would be halved. Therefore, it is necessary to realize a novel function for efficiently executing the transition from the standby state to hibernate state while suppressing power consumption.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing an external appearance of an information processing apparatus according to an embodiment of the invention;

FIG. 2 is an exemplary block diagram showing a system configuration of the information processing apparatus shown in FIG. 1;

FIG. 3 is an exemplary block diagram showing a structure of a hard disk drive which is provided in the information processing apparatus shown in FIG. 1;

FIG. 4 is an exemplary block diagram showing a functional structure for executing a system state control of the information processing apparatus shown in FIG. 1;

FIG. 5 is an exemplary flowchart showing the procedure of a system state control process which is executed by the information processing apparatus shown in FIG. 1; and

FIG. 6 shows an example of a setup screen which is used in the information processing apparatus shown in FIG. 1.

### DETAILED DESCRIPTION

Various embodiments according to the invention will be described hereinafter with reference to the accompanying drawings. In general, according to one embodiment of the invention, an information processing apparatus including: a processor; a main memory; a hard disk drive; a first state control unit which stores in the hard disk drive, in response to occurrence of a sleep event which instructs transition of a system state of the information processing apparatus from a working state to a sleep state, system information for restoring a system operational environment of the information processing apparatus at a time immediately before the transition to the sleep state, and then transitions the system state from the working state to a standby state in which power is supplied to the main memory that stores the system information and no power is supplied to the processor and the hard disk drive; an alarm generating unit which generates, after a predetermined time has passed since the transition of the system state to the standby state, an alarm signal for instructing transition to a hibernate state in which no power is supplied to the processor, the main memory and the hard disk drive and the system information is retained by the hard disk drive; a restoration process unit which supplies power to the processor in a state in which the hard disk drive is kept in an inactive state, when a wakeup event has occurred during a time period in which the system state is the standby state, thereby restoring the system state from the standby state to the working state; a determination unit which executes, by means of the processor, a determination process of determining whether a factor of occurrence of the wakeup event is occurrence of the alarm signal, in response to the restoration to the working state; and a second state control unit which stops power supply to the processor and the main memory if the factor of occurrence of the wakeup event is the occurrence of the alarm signal, thereby transitioning the system state to the hibernate state, and sets the hard disk drive in an active state if the factor of occurrence of the wakeup event is not the occurrence of the alarm signal.

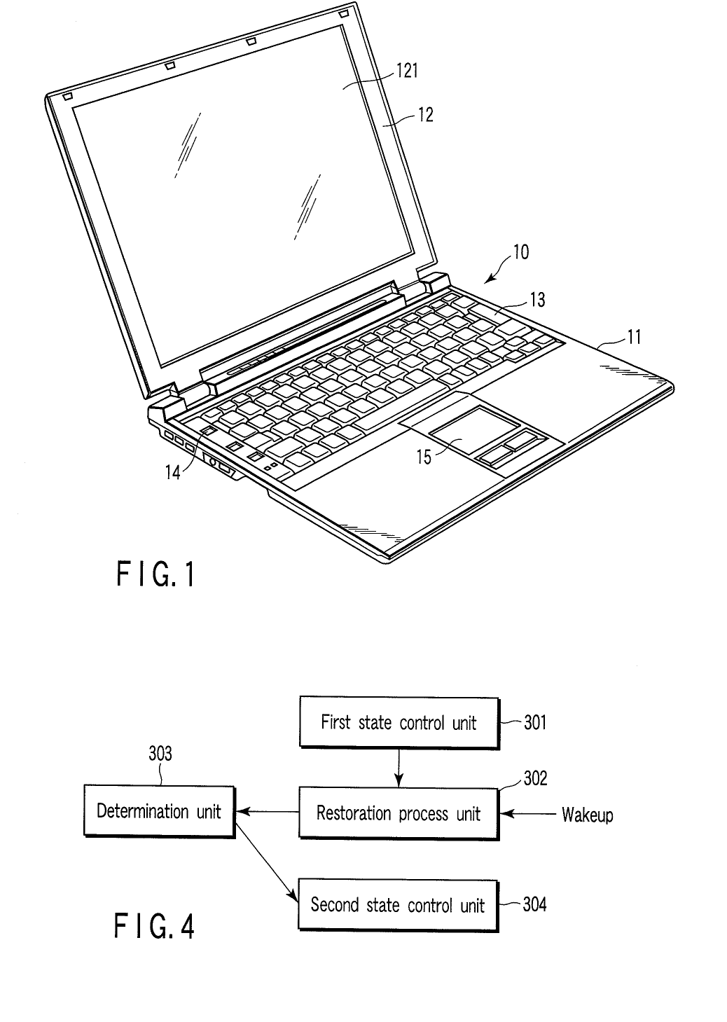

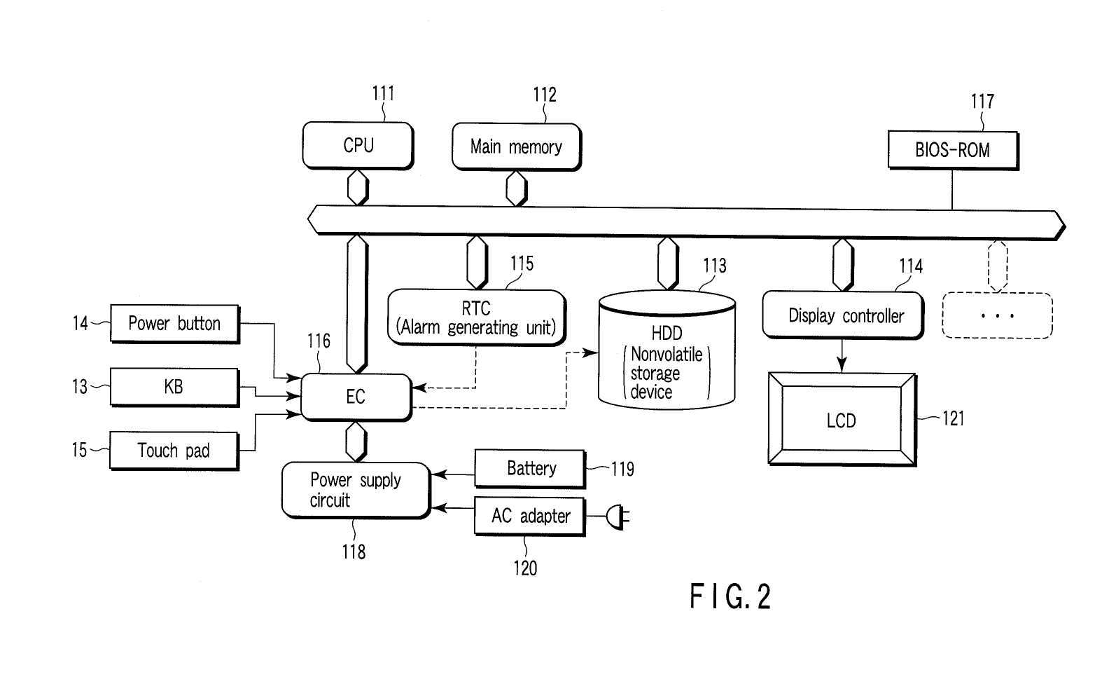

Referring to FIG. 1 and FIG. 2, the structure of an information processing apparatus according to the embodiment of the invention is described. The information processing apparatus is realized, for example, as a battery-powerable notebook portable personal computer 10.

FIG. 1 is a perspective view showing the computer 10, as viewed from the front side, in the state in which a display unit thereof is opened.

The computer 10 comprises a main body 11 and a display unit 12. A display device that is composed of an LCD (Liquid Crystal Display) 121 is built in the display unit 12. The display screen of the LCD 121 is positioned at an approximately central part of the display unit 12.

The display unit 12 is attached to the main body 11 such that the display unit 12 is freely rotatable between an open position where a top surface of the main body 11 is exposed and a closed position where the top surface of the main body 11 is covered. The main body 11 has a thin box-shaped casing. A keyboard 13, a power switch 14 for powering on/off the computer 10, and a touch pad 15 are disposed on the top surface of the main body 11.

FIG. 2 shows the system configuration of the computer 10.

The computer 10 comprises a CPU 111, a main memory 112, a hard disk drive (HDD) 113, a display controller 114, a real-time clock (RTC) 115, an embedded controller (EC) 116, a BIOS-ROM 117, a power supply circuit 118, and a battery 119.

The CPU 111 is a processor that controls the operation of the components of the computer 10. The CPU (processor) 111 executes an operating system and various application programs, which are loaded from the HDD 113 into the main memory 112. The main memory 112 is composed of a volatile memory, and can retain data only while the main memory 112 is being supplied with power. The CPU 111 also executes a basic input/output system (BIOS) that is stored in the BIOS-ROM 117. The BIOS is a program for hardware control.

In the present embodiment, the operating system and BIOS cooperate to execute a process for automatically transitioning the system state from a standby state to a hibernate state in the state in which the HDD 113 is kept in an inactive state.

The standby state (also referred to as “suspend state”) is a power-saving state in which almost all devices, excluding the main memory 112 that retains system information for restoring the system operational environment (also referred to as “system context”) of the computer 10 at a time immediately before the transition to the standby state, are powered off. If a wakeup event occurs in the standby state, the system state is restored from the standby state to a working state, with use of the system information stored in the main memory 112. Thereby, work can be resumed from the state immediately before the transition to the standby state.

The hibernate state is a power-saving state in which almost all devices, including the main memory 112, are powered off in the state in which the system information is stored in the hard disk drive 113. If a wakeup event occurs in the hibernate state, the system state is restored from the hibernate state to the working state, with use of the system information stored in the hard disk drive 113. Thereby, work can be resumed from the state immediately before the transition to the hibernate state.

For example, the standby state corresponds to S3 that is defined in the Advanced Configuration and Power Interface (ACPI) specification. The hibernate corresponds to S4 defined in the ACPI specification.

Specifically, in the ACPI specification, system states S0 to S5 are defined. The system state S0 is a working state (i.e. a state in which the system is powered on and software is being executed), and S5 is an off-state (i.e. a state in which the system is powered off and no software is executed). The system states S1 to S4 are intermediate states between the working state and off-state, that is, sleep states (the context of software immediately before the transition to the sleep state is saved, and the software is halted in the sleep state). The relationship in magnitude of power consumption between these system states is S0>S1>S2>S3>S4>S5.

In the present embodiment, a sleep function in which the standby state and hibernate state are combined is used. In this sleep function (hereinafter referred to as “hybrid sleep function”), the system state is transitioned to the standby state after the system information is stored in the hard disk drive 113, and the system state is transitioned to the hibernate state after a predetermined time has passed since the transition to the standby state. In usual cases, the system can quickly be resumed from the main memory 112. In addition, since the system state automatically transitions to the hibernate state after a predetermined time has passed since the transition to the standby state, it is possible to prevent power from being consumed for a long time for the backup of the main memory 112, and to increase, for example, the battery driving time.

In order to further improve the hybrid sleep function, the computer 10 is equipped with a function for executing the transition from the standby state to the hibernate state in the state in which the hard disk drive 113 is kept in the inactive state, as described above.

The hard disk drive 113 is a nonvolatile storage device, and stores the operating system, various application programs and various data. The hard disk drive 113 includes at least a disk storage medium as a storage medium. The disk storage medium is a magnetic disk that is called “hard disk”. The disk storage medium is not rotated during the period in which the hard disk drive 113 is in the inactive state. As described above, the transition from the standby state to the hibernate state is executed in the state in which the hard disk drive 113 is kept in the inactive state. Thus, the power consumption necessary for the transition from the standby state to the hibernate state can be reduced. In addition, for example, since the hard disk is prevented from suddenly beginning to rotate while the computer 10 is being moved, the occurrence of, e.g. disk crash can be prevented.

The display controller 114 is a controller which controls the LCD 121 that is used as a display monitor of the computer 10.

The real-time clock (RTC) 115 is a clock module (timer) which measures a date and time. The real-time clock (RTC) 115 is always supplied with power from a dedicated battery for the real-time clock (RTC) 115 or power from the power supply circuit 118. The real-time clock (RTC) 115 has a function of generating an alarm signal when a time that is designated by the CPU 111 has passed, or when the present date/time has reached the date/time designated by the CPU 111. In the present embodiment, the real-time clock (RTC) 115 is used in order to inform the embedded controller (EC) 116 of the arrival of the timing of transition from the standby state to the hibernate state. To be more specific, the real-time clock (RTC) 115 is an alarm generating unit which generates an alarm signal for instructing the transition to the hibernate state after a predetermined time, which is designated by the CPU 111, has passed since the system state was transitioned from the working state to the standby state.

The embedded controller (EC) 116 is a controller which cooperates with the power supply circuit 118 to control power supply to the respective modules in the system. The embedded controller (EC) 116 is always supplied with power from the power supply circuit 118. If a wakeup event, which instructs activation of the system, such as an operation of the power button 14 by the user or an alarm signal from the RTC 115, has occurred during the time period in which the present system is in the standby state, the embedded controller (EC) 116 powers on the computer 10 in the state in which the HDD 113 is kept in the inactive state. In order to keep the HDD 113 in the inactive state, the embedded controller (EC) 116 executes, for example, a process of powering on the computer 10 in the state in which the HDD 113 is kept in the power-off state, or a process of supplying power to almost all devices including the HDD 113 in the state in which the disk storage medium in the HDD 113 is prohibited from rotating. The prohibition of rotation of the disk storage medium can be realized, for example, by keeping a reset signal for the HDD 113 in the active state. Even if the HDD 113 is powered on, the HDD 113 is kept in the inactive state while the reset signal is in the active state, and the HDD 113 does not operate. If the reset signal changes from the active state to the inactive state, the HDD 113 is set in the active state and begins to operate.

The power supply circuit 118 supplies power to the respective modules by using power from the battery 119 provided in the computer main body 11 or external power supplied via an AC adapter 120.

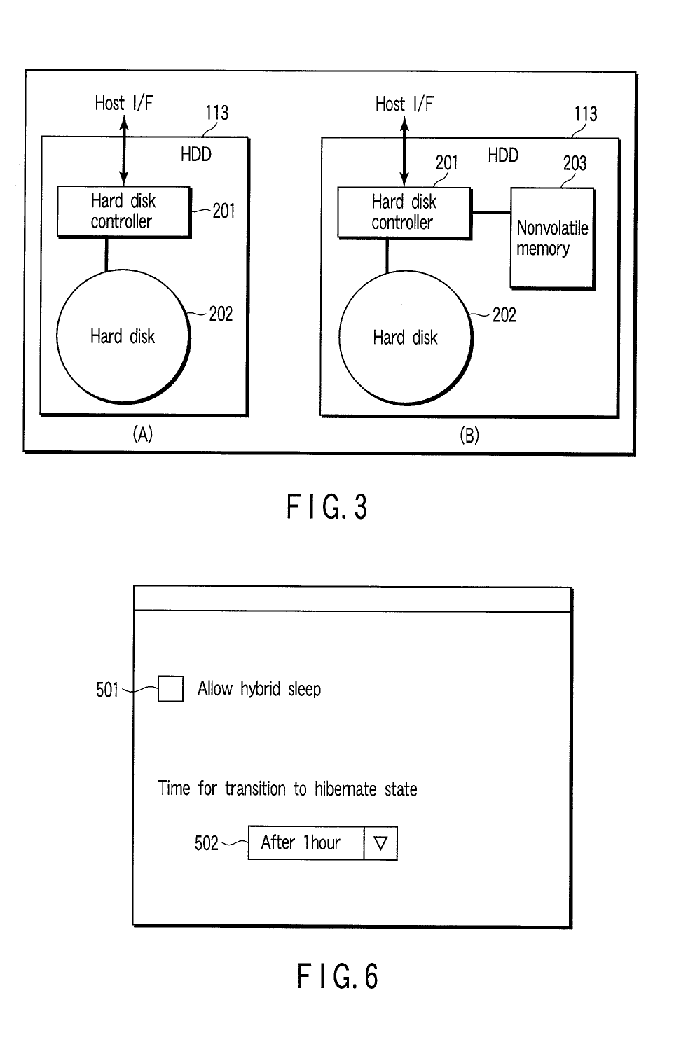

Next, referring to FIG. 3, examples of the structure of the HDD 113 are described.

Part (A) of FIG. 3 shows an HDD 113 which includes a hard disk controller 201 and a hard disk 202. The hard disk 202 is a disk storage medium. The hard disk controller 201 controls an operation for reading out data from the hard disk (disk storage medium) 202 and an operation for writing data in the hard disk (disk storage medium) 202 in accordance with a command that is delivered from the CPU 111 via a host interface such as a serial ATA (SATA) or a parallel ATA (PATA). The data write to the hard disk (disk storage medium) 202 and data read from the hard disk 202 are executed by using a mechanical driving mechanism which is provided in the HDD 113. This driving mechanism includes a spindle motor which rotates the hard disk 202, a head for data write and data read, and an actuator for moving the head. The above-described system information is written in the hard disk 202.

While the HDD 113 is in the inactive state, the hard disk controller 201 does not operate, nor does the hard disk 202 rotate.

If the HDD 113 is set in the active state, the hard disk controller 201 begins to operate, and is able to receive a command from the CPU 111. In addition, the hard disk 202 is spun up under the control of the hard disk controller 201.

Part (B) of FIG. 3 shows an HDD 113 which is a disk drive generally called “hybrid disk drive”. This HDD 113 includes a nonvolatile memory 203 in addition to the above-described hard disk controller 201 and hard disk 202. The nonvolatile memory 203 is composed of, e.g. a NAND-type flash EEPROM. The hard disk controller 201 selectively accesses the hard disk 202 and nonvolatile memory 203. The above-described system information is stored, for example, in the nonvolatile memory 203.

While the HDD 113 is in the inactive state, the hard disk controller 201 does not operate, nor does the hard disk 202 rotate. If the HDD 113 is set in the active state, the hard disk controller 201 begins to operate, and is able to receive a command from the CPU 111. There is no need to spin up the hard disk 202 until a command to request data read from the hard disk 202 is sent from the CPU 111.

Next, referring to FIG. 4, a description is given of the functional structure for realizing the system state transition.

The above-described improved hybrid sleep function is executed by using a first state control unit 301, a restoration process unit 302, a determination unit 303 and a second state control unit 304.

The first state control unit 301 is realized by, for example, the operating system and BIOS. Responding to occurrence of a sleep event which instructs transition of the system state from the working state to the sleep state, the first state control unit 301 stores in the HDD 113 the system information for restoring the system operational environment of the computer 10 at a time immediately before the transition to the sleep state, and then transitions the system state from the working state to the standby state in which power is supplied to the main memory 112 that stores the system information and no power is supplied to the other modules including the CPU 111 and HDD 113. In addition, the first state control unit 301 executes a time setting process for causing the RTC 115 to generate the above-described alarm signal for instructing the transition from the standby state to the hibernate state. In this time setting process, time information (alarm time), which indicates a time period from a timing when the system has transitioned to the standby state to a timing when the system is to transition to the hibernate state, is set in the RTC 115.

Examples of the sleep event are an operation of the power button 14 by the user, and an operation of a sleep button by the user. The sleep button is displayed on the display screen.

The restoration process unit 302 is realized, for example, by the EC 116 and BIOS. When a wakeup event has occurred while the system state is the standby state, the restoration process unit 302 supplies power to the respective modules including the CPU 111 in the state in which the HDD 113 is kept in the inactive state, thereby restoring the system state from the standby state to the working state by using the system information stored in the main memory 111. In this restoration process, the operation of the CPU 111 is resumed and thus the operation of the operating system, which has been halted, is resumed.

The determination unit 303 is realized, for example, by the operating system. In response to the restoration to the working state, that is, in response to the resumption of the operation of the CPU 111, the determination unit 303 executes, by means of the CPU 111, a determination process for determining whether the factor of occurrence of the wakeup event is the occurrence of the above-described alarm signal that instructs transition from the standby state to the hibernate state. For example, if the elapsed time from the transition to the standby state to the resumption of the operation of the CPU 111 corresponds to the above-described alarm time, the determination unit 303 determines that the factor of occurrence of the wakeup event is the occurrence of the above-described alarm signal that instructs transition from the standby state to the hibernate state. In some cases, the alarm function of the RTC 115 is also used as a task scheduling function of the operating system, by which a specified application program is started at a predetermined date/time. By executing the above-described determination process by means of the CPU 111, i.e. the operating system, it becomes possible to exactly determine whether the factor of occurrence of the wakeup event is the occurrence of the above-described alarm signal that instructs transition from the standby state to the hibernate state.

The second state control unit 304 is realized, for example, by the BIOS. If the factor of occurrence of the wakeup event is the occurrence of the above-described alarm signal that instructs transition from the standby state to the hibernate state, the second state control unit 304 cooperates with the EC 116 to stop power supply to almost all modules which are in operation, including the CPU 111 and main memory 112, thereby transitioning the system state to the hibernate state.

On the other hand, if the factor of occurrence of the wakeup event is not the occurrence of the above-described alarm signal that instructs transition from the standby state to the hibernate state, the second state control unit 304 cooperates with the EC 116 to execute a process for setting the HDD 113 in the active state. Thus, the system completely transitions to the working state, and can resume the suspended work.

Next, referring to a flowchart of FIG. 5, the procedure of the state transition control process of the computer 10 is described.

If a wakeup event, such as an operation of the power button 14 by the user, occurs during the time of the system-off state (including the hibernate state), the EC 116 supplies power to the modules in the system, which include the CPU 111, main memory 112 and nonvolatile storage device (HDD 113), thereby powering on the computer 10. In this case, the HDD 113 is set in the active state. The CPU 111 begins to operate. The CPU 111, that is, the BIOS, refers to a status register, for instance, in the EC 116, and determines whether the system state has been set in the hibernate state or not (block S101).

If the system state has been set in the off-state (NO in block S101), the CPU 111, i.e. the BIOS, executes the process of booting up the operating system (OS) from the nonvolatile storage device (HDD 113) (block S102). Thereby, the system transitions to the working state. On the other hand, if the system state has been set in the hibernate state (YES in block S101), the CPU 111, or the BIOS, executes the process for restoring the system from the nonvolatile storage device (HDD 113) (block S103). In block S103, the BIOS transfers the system information from the nonvolatile storage device (HDD 113) to the main memory 112, and restores the system operational environment by using the system information that has been stored in the nonvolatile storage device (HDD 113). Thereby, the system state restores from the hibernate state to the working state.

If an off-state transition event, such as a shut-down request from the user, occurs in the system working state (YES in block S104), the CPU 111, i.e. the BIOS or the operating system, issues a request for the power supply for the off-state to the EC 116, and stops power supply to almost all modules in the system, which include the CPU 111, main memory 112 and HDD 113 (block S107). Thereby, the system transitions to the off-state.

If a hibernate-state transition event, such as a hibernate request from the user, occurs in the system working state (YES in block S105), the CPU 111, or the operating system, stores in the nonvolatile storage device (HDD 113) the system information (e.g. content in the main memory 112) for restoring the system operational environment at a time immediately before the transition to the hibernate state (block S108), issues via the BIOS a request for the power supply for the hibernate state to the EC 116, and stops power supply to almost all modules in the system, which include the CPU 111, main memory 112 and HDD 113 (block S109). Thereby, the system transitions to the hibernate state.

If a sleep event which instructs transition to the sleep state, such as a standby request from the user, occurs in the system working state, the CPU 111, or the operating system, determines whether the execution of the above-described hybrid sleep function is permitted, that is, whether the system information needs to be stored in the nonvolatile storage device (HDD 113) (block S110).

If the execution of the hybrid sleep function is permitted (YES in block S110), the CPU 111, or the operating system, executes the process of setting the alarm time in the RTC 115, and the process of storing in the nonvolatile storage device (HDD 113) the system information (e.g. content in the main memory 112) for restoring the system operational environment at a time immediately before the transition to the standby state (sleep state) (block S111). Further, the CPU 111, or the operating system, issues a request for the power supply for the standby state to the EC 116, and stops power supply to almost all modules excluding the main memory 112 that stores the system information (block S112). Thereby, the system state transitions from the working state to the standby state.

If the execution of the hybrid sleep function is not permitted (NO in block S110), the CPU 111, or the operating system, skips the process of block S111, and issues a request for the power supply for the standby state to the EC 116 and stops power supply to almost all modules excluding the main memory 112 that stores the system information (block S112). Thereby, the system state transitions from the working state to the standby state.

If a wakeup event (factor for resume), such as an operation of the power switch 14 by the user or occurrence of the alarm signal from the EC 116, occurs during the period in which the system is in the standby state (YES in block S113), the EC 116 supplies power to the modules including the CPU 111 in the state in which the nonvolatile storage device (HDD 113) is kept in the inactive state, and resumes the operation of the CPU 111, thereby restoring the system from the volatile memory device (main memory 112) (block S114). In block S114, the system operational environment at the time immediately before the transition to the standby state is restored by the system information stored in the volatile memory device (main memory 112). Thereby, the system state is restored from the standby state to the working state. In this manner, the operation of the CPU 111 is resumed in the state in which the nonvolatile storage device (HDD 113) is kept in the inactive state, that is, in the state in which the spin-up of the disk storage medium is prohibited.

If the system state is restored from the standby state to the working state, the CPU 111, or the operating system, determines whether the factor of occurrence of the wakeup event is the occurrence of the above-described alarm signal that instructs transition from the standby state to the hibernate state (block S115).

If the CPU 111, or the operating system, determines that the factor of occurrence of the wakeup event is the occurrence of the above-described alarm signal that instructs transition from the standby state to the hibernate state (YES in block S115), the CPU 111, or the operating system, issues via the BIOS a request for the power supply for the hibernate state to the EC 116, and stops power supply to almost all modules in the system, which include the CPU 111, main memory 112 and HDD 113 (block S109). Thereby, the system state transitions from the working state to the hibernate state. If no power is supplied to the HDD 113 in block S114, there is no need to execute a process of stopping power supply to the HDD 113 in block S109.

As has been described above, the process of blocks S114 and S115 is executed in the state in which the nonvolatile storage device (HDD 113) is kept in the inactive state. Thus, the transition from the standby state to the hibernate state can efficiently be executed in the state in which the power consumption of the HDD 113 is suppressed. In addition, since the hard disk is prevented from beginning to rotate, for example, while the computer 10 is being moved, the occurrence of, e.g. disk crash can be prevented. Moreover, since heat production of the HDD 113 due to the rotation of the hard disk can be suppressed, it is possible to prevent a sudden rise in temperature of the computer 10 in the state in which the computer 10 is put in the user's bag, and the safety can be improved.

If the CPU 111, or the operating system, determines that the factor of occurrence of the wakeup event is not the occurrence of the above-described alarm signal that instructs transition from the standby state to the hibernate state (NO in block S115), the CPU 111, or the operating system, executes a process for setting the HDD 113 in the active state (block S116). In block S116, for example, a process of supplying power to the HDD 113 or a process of switching the state of the reset signal from the active state to the inactive state, which is delivered to the HDD 113 that is being supplied with power, is executed.

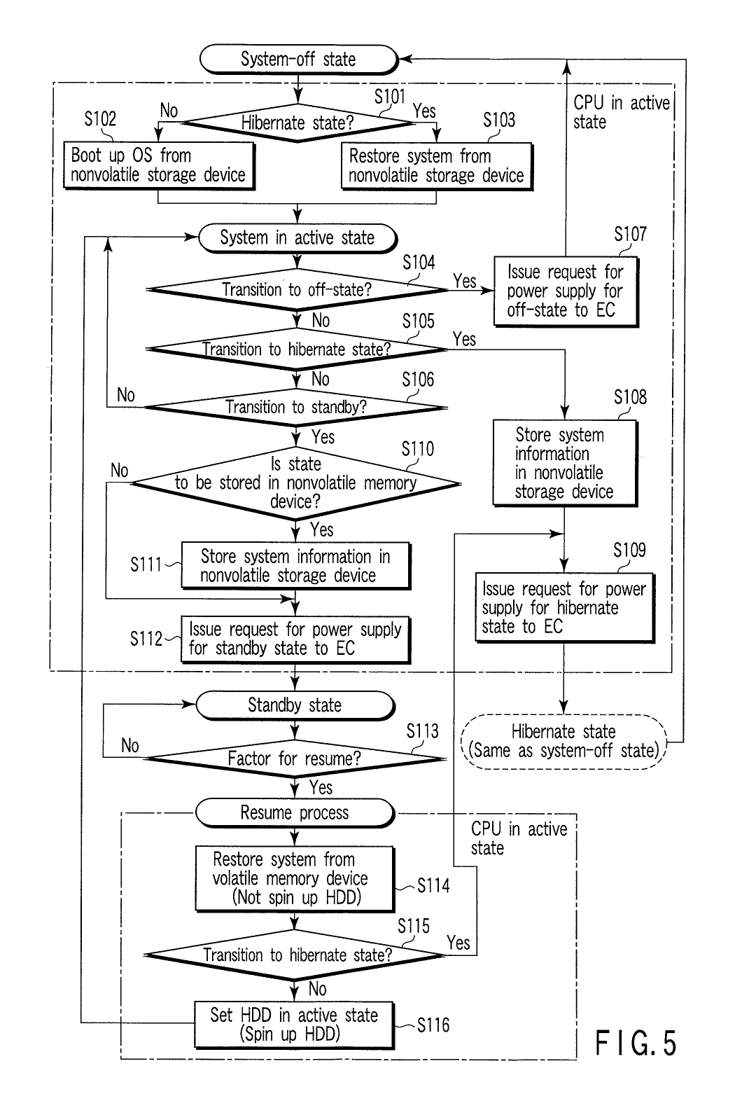

FIG. 6 shows an example of a setup screen relating to power management, which is displayed on the display screen of the LCD 121 by the operating system.

The setup screen displays a check box 501 for prompting the user to designate permission/prohibition of the execution of the hybrid sleep function, and a pull-down menu 502 for prompting the user to designate after how many hours the standby state is to be transitioned to the hibernate state. The user can easily instruct permission/prohibition of the execution of the hybrid sleep function by checking the check box 501 or clearing the check box 501. In addition, using the pull-down menu 502, the user can designate the time at which the standby state is to be transitioned to the hibernate state.

As has been described above, according to the present embodiment, the power consumption of the HDD 113 in the transition process from the standby state to the hibernate state can be reduced, and the transition from the standby state to the hibernate state can efficiently be executed. In addition, for example, since the hard disk is prevented from suddenly beginning to rotate while the computer 10 is being carried and moved by the user, the safety can be improved.

If at least the CPU 111 and main memory 112 are powered on, the operating system begins to operate and can execute the determination process in block S115. Thus, in block S114, it should suffice if power is supplied to at least the CPU 111 alone in the state in which the HDD 113 is kept in the inactive state. In this case, in block S116, not only the process of setting the HDD 113 in the active state, but also the process of supplying power to the other modules, which are powered off, is executed.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor;
a main memory comprising system information for restoring a system operational environment of the information processing apparatus;
a hard disk drive;
a first state control unit configured to store, in response to an instruction to transition a system state of the information processing apparatus from a working state to a standby state, the system information, the first state control unit further configured to transition the system state from the working state to the standby state after storing the system information, wherein when the information processing apparatus is in the standby state power is supplied to the main memory, no power is supplied to the processor, and no power is supplied to the hard disk drive;
an alarm generating unit configured to generate an alarm signal a predetermined amount of time after transitioning to the standby state, the alarm signal comprising an instruction to transition the system state from the standby state to a hibernate state, wherein when the information processing apparatus is in the hibernate state no power is supplied to the processor, no power is supplied to the main memory, and no power is supplied to the hard disk drive;
a restoration process unit configured to restore the system state from the standby state to the working state when a wakeup event has occurred by supplying power to the processor while the hard disk drive is kept in an inactive state;
a determination unit configured to determine, in response to the restoration to the working state, whether the wakeup event corresponds to the alarm signal; and
a second state control unit configured to transition the system state to the hibernate state by stopping the power supply to the processor and the main memory when the wakeup event corresponds to the alarm signal, and configured to set the hard disk drive in an active state when the wakeup event is not the alarm signal.

2. The information processing apparatus according to claim 1, wherein the hard disk drive comprises a disk storage medium and the disk storage medium is not rotated when the hard disk drive is in the inactive state.

3. The information processing apparatus according to claim 1, wherein, when the wakeup event has occurred and the information processing apparatus is in the standby state, the restoration process unit supplies power to the processor and the hard disk drive is kept in a power-off state.

4. The information processing apparatus according to claim 1, wherein, when the wakeup event has occurred and the information processing apparatus is in the standby state, the restoration process unit supplies power to the hard disk drive and the processor, and rotation of a disk storage medium in the hard disk drive is prohibited.

5. The information processing apparatus according to claim 1, further comprising means for restoring the system state to the working state when a wakeup event has occurred and the system state is the hibernate state.

6. A method for controlling a system state of an information processing apparatus comprising a processor, a main memory and a hard disk drive, the method comprising:
storing system information for restoring a system operational environment of the information processing system in the hard disk drive in response to occurrence an instruction to transition the system state of the information processing apparatus from a working state to a standby state;
transitioning the system state from the working state to the standby state, wherein when the information processing apparatus is in the standby state power is supplied to the main memory, no power is supplied to the processor, and no power is supplied to the hard disk drive;
generating an alarm signal a predetermined amount of time after transitioning to the standby state, the alarm signal comprising an instruction to transition the system state from the standby state to a hibernate state, wherein when the information processing apparatus is in the hibernate state no power is supplied to the processor, no power is supplied to the main memory, and no power is supplied to the hard disk drive;
restoring the information processing apparatus from the standby state to the working state when a wakeup event has occurred by supplying power to the processor while the hard disk drive is kept in an inactive state;
determining whether the wakeup event corresponds to the alarm signal in response to the restoration to the working state;
stopping the power supply to the processor and the main memory when the wakeup event corresponds to the alarm signal, thereby transitioning the system state to the hibernate state; and
setting the hard disk drive in an active state when the wakeup event does not correspond to the alarm signal.

7. The method according to claim 6, wherein the hard disk drive comprises a disk storage medium and the disk storage medium is not rotated when the hard disk drive is in the inactive state.

8. The system state control method according to claim 6, wherein restoring the information processing apparatus from the standby state to the working state comprises supplying power to the processor while the hard disk drive is kept in a power-off state.

9. The system state control method according to claim 6, wherein restoring the information processing apparatus from the standby state to the working state comprises supplying power to the hard disk drive and the processor while rotation of the disk storage medium in the hard disk drive is prohibited.

10. The system state control method according to claim 6, further comprising restoring the system state to the working state when a wakeup event has occurred while the system state is the hibernate state.
